(19) United States
(12) Patent Application Publication
(10) Pub. No.: US 2026/0309074 A1
(43) Pub. Date: Oct. 8, 2026

(54) ROTARY INTERNAL COMBUSTION ENGINE WITH INTEGRATED PUMP

(71) Applicant: PRATT & WHITNEY CANADA CORP., Longueuil (CA)

(72) Inventors: Jeremie BARBERGER, Longueuil (CA); Frederic ROY, Longueuil (CA)

(21) Appl. No.: 19/170,684

(22) Filed: Apr. 4, 2025

(51) Int. Cl. F02B 53/14; F01P 3/02; F01P 5/12; F02B 53/00

(52) U.S. Cl. CPC F02B 53/14; F01P 3/02; F01P 5/12; F02B 55/08; F02B 55/10; F04C 2/082; F04C 2/084; F04C 2/18; F04C 11/001; F02B 2053/005

(57) ABSTRACT

A rotary internal combustion engine, has: a housing having walls defining a rotor cavity, the walls having inner faces exposed to the rotor cavity and outer faces opposed to the inner faces, the walls defining passages between the inner faces and the outer faces, a wall of the walls defining a pump-receiving cavity between an outer face of the outer faces and an inner face of the inner faces that corresponds to that outer face; a rotor received within the rotor cavity and drivingly engaged to an output shaft; and a pump system into the pump-receiving cavity and including a first inlet connectable to a fluid source, a first outlet and a second inlet both connected to the passages, and a second outlet connectable to the fluid source, the pump system operable to generate a fluid flow between the inlets and the outlets.

### TECHNICAL FIELD

The application relates generally to internal combustion engines and, more particularly, to rotary internal combustion engines and to fluid systems of such engines.

### BACKGROUND

Combustion chambers of a rotary engine, such as a Wankel engine, are delimited radially by a rotor and rotor housing and axially by a side or end housing. The side/end housing faces the combustion chambers and is thus subjected to high pressure and thermal loads. During use, the rotor housing becomes hot and requires cooling. Existing fluid systems include fluid tank and fluid pump. These systems may be satisfactory, but improvements are sought.

### SUMMARY

In one aspect, there is provided a rotary internal combustion engine, comprising: a housing having walls defining a rotor cavity, the walls having inner faces exposed to the rotor cavity and outer faces opposed to the inner faces, the walls defining passages between the inner faces and the outer faces, a wall of the walls defining a pump-receiving cavity between an outer face of the outer faces and an inner face of the inner faces that corresponds to that outer face, the pump-receiving cavity in fluid communication with the passages; a rotor rotatably received within the rotor cavity of the housing, the rotor drivingly engaged to an output shaft; and a pump system received into the pump-receiving cavity of the housing, the pump system including a first inlet fluidly connectable to a fluid source, a first outlet fluidly connected to the passages, a second inlet fluidly connected to the passages, and a second outlet fluidly connectable to the fluid source, the pump system operable to generate a fluid flow from the first inlet to the first outlet and a scavenge flow from the second inlet to the second outlet.

The rotary internal combustion engine described above may include any of the following features, in any combinations.

In some embodiments, the pump system includes: a first pump driving a flow of the fluid from the first inlet to the first outlet; and a second pump driving a flow of the fluid from the second inlet to the second outlet.

In some embodiments, the first pump and the second pump are gear pumps.

In some embodiments, the gear pumps include a central gear, a first lateral gear meshed with the central gear, and a second lateral gear meshed with the central gear, the first lateral gear and the second lateral gear disposed on respective opposite faces of the central gear, the first pump including the central gear and the first lateral gear, the second pump including the central gear and the second lateral gear.

In some embodiments, the first lateral gear is axially offset from the second lateral gear relative to an axis of rotation of the first lateral gear.

In some embodiments, the first pump and the second pump are unbalanced vane pumps.

In some embodiments, the unbalanced vane pumps include a first pump rotor and a second pump rotor axially offset from one another relative to a rotational axis of the first pump rotor.

In some embodiments, the pump system includes a single balanced vane pump defining the first inlet, the first outlet, the second inlet, and the second outlet.

In some embodiments, the pump system is drivingly engaged by the output shaft.

In another aspect, there is provided an aircraft power plant, comprising: an output shaft for driving a rotatable load; a fluid tank; a rotary internal combustion engine having: a housing having interconnected walls defining rotor cavities, the interconnected walls having inner faces exposed to the rotor cavities and outer faces opposed to the inner faces, fluid passages defined by the interconnected walls between the inner faces and the outer faces; a pump-receiving cavity defined between a corresponding one of the outer faces and a corresponding one of the inner faces of a wall of the interconnected walls, the pump-receiving cavity in fluid communication with the passages; and rotors each rotatably received within a respective one of the rotor cavities of the housing, the rotors drivingly engaged to the output shaft; and a main pump received into the pump-receiving cavity, the main pump having a main inlet fluidly connected to the fluid tank and a main outlet fluidly connected to inlets of the fluid passages of the housing; and a scavenge pump received into the pump-receiving cavity, the scavenge pump having a scavenge inlet fluidly connected to outlets of the fluid passages and a scavenge outlet fluidly connected to the fluid tank.

The aircraft power plant described above may include any of the following features, in any combinations.

In some embodiments, the fluid tank is defined by a fluid-receiving volume defined by the housing.

In some embodiments, the main pump and the scavenge pump are gear pumps.

In some embodiments, the gear pumps include a central gear, a first lateral gear meshed with the central gear, and a second lateral gear meshed with the central gear, the first lateral gear and the second lateral gear disposed on respective opposite faces of the central gear, the first pump including the central gear and the first lateral gear, the second pump including the central gear and the second lateral gear.

In some embodiments, the first lateral gear is axially offset from the second lateral gear relative to an axis of rotation of the first lateral gear.

In some embodiments, a gear of the central gear, the first lateral gear, and the second lateral gear is drivingly engaged by the output shaft.

In some embodiments, the main pump and the scavenge pump are unbalanced vane pumps.

In some embodiments, the unbalanced vane pumps include a first pump rotor and a second pump rotor axially offset from one another relative to a rotational axis of the first pump rotor.

In some embodiments, the main pump and the scavenge pump are defined by a single balanced vane pump defining the main inlet, the main outlet, the scavenge inlet, and the scavenge outlet.

In some embodiments, the interconnected walls include end walls and peripheral walls located between the end walls, the end walls and the peripheral wall conjointly defining a rotor cavity of the rotor cavities, the passages extending through interfaces, an interface of the interfaces defined between an end wall of the end walls and a peripheral wall of the peripheral walls.

In some embodiments, the pump-receiving cavity is defined by the peripheral wall.

### DESCRIPTION OF THE DRAWINGS

Reference is now made to the accompanying figures in which:

FIG. 1 is a schematic view of an aircraft power plant;

FIG. 2 is a schematic cross-sectional view of a housing for a rotary internal combustion engine of the aircraft power plant of FIG. 1 taken on a plane containing a rotation axis of a rotor of the internal combustion engine;

FIG. 3 is a schematic cross-sectional view of another housing for the rotary internal combustion engine of the aircraft power plant of FIG. 1 taken on a plane containing the rotation axis of the rotor of the internal combustion engine;

FIG. 4 is a cross-sectional view, taken on a plane intersecting the rotation axis of the rotor, of a peripheral wall of the housing of FIG. 2 illustrating the integration of a pump system into said peripheral wall;

FIG. 5 is a plan view of the pump system of FIG. 4;

FIG. 6 is an enlarged view of a portion of FIG. 4 illustrating one of two pumps of the pump system shown in FIGS. 4 and 5;

FIG. 7 is an enlarged view of another portion of FIG. 4 illustrating the other of the two pumps of the pump system shown in FIGS. 4 and 5;

FIG. 8 is a cross-sectional view, taken on a plane intersecting the rotation axis of the rotor, of a peripheral wall of the housing of FIG. 2 illustrating integration of another pump system into said peripheral wall;

FIG. 9 is a plan view of the pump system of FIG. 8; and

FIG. 10 is a cross-sectional view, taken on a plane intersecting the rotation axis of the rotor, of a peripheral wall of the housing of FIG. 2 illustrating integration of another possible pump system into said peripheral wall.

### DETAILED DESCRIPTION

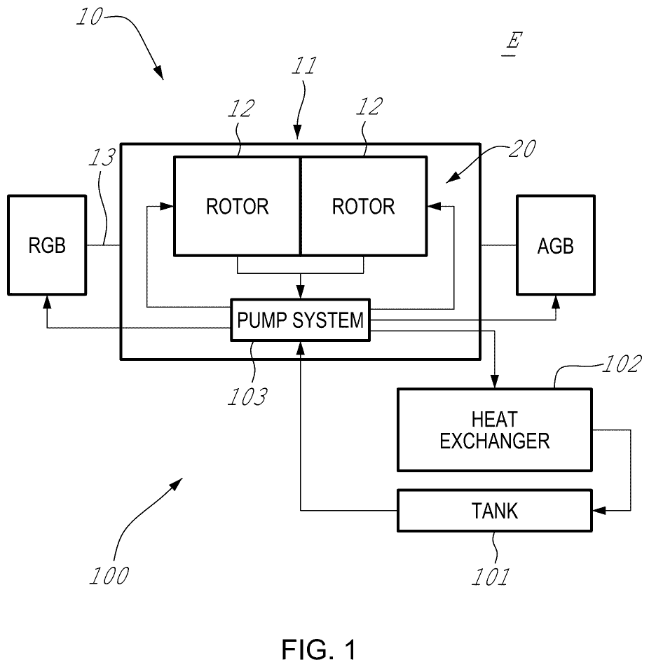

Referring to FIG. 1, an aircraft power plant is shown at 10 and includes a rotary internal combustion engine 11 having a one or more rotor 12, two rotors 12 in this embodiment, in driving engagement with an output shaft 13. In this configuration, the output shaft 13 extends through both of opposite sides of the rotary internal combustion engine 11. The output shaft 13 is thus drivingly engaged to a reduction gearbox (RBG) on one side of the rotary internal combustion engine 11 and to an accessory gearbox (AGB) on the other side of the rotary internal combustion engine 11. The two gearboxes may be located on the same side in some embodiments. The RGB has an output drivingly engageable to a rotatable load, such as a propeller. The AGB receives an input form the output shaft 13 and drives accessories, such as an engine starter, pump(s), electric generator/motor, and so on.

In use, the rotary internal combustion engine 11 generates heat that needs to be dissipated to an environment E outside the rotary internal combustion engine 11. Also, some components of the rotary internal combustion engine 11 needs to be lubricated during use. These components include, for instance, seals of the rotors 12, bearings, gears, and so on. To do so, the rotary internal combustion engine 11 includes a fluid system 100 that flows a fluid through a housing of the rotary internal combustion engine 11. The fluid system 100 includes a fluid tank 101, a heat exchanger 102 in fluid communication with the fluid tank 101, and a pump system 103, which may include a main pump and a scavenge pump. The pump system 103 is configured to generate a flow of fluid from the fluid tank 101 to the rotary internal combustion engine 11 and back from the rotary internal combustion engine 11 to the heat exchanger 102 where heat is transferred to another fluid (e.g., air, fuel, oil, etc.), and back to the fluid tank 101 and the cycles continues.

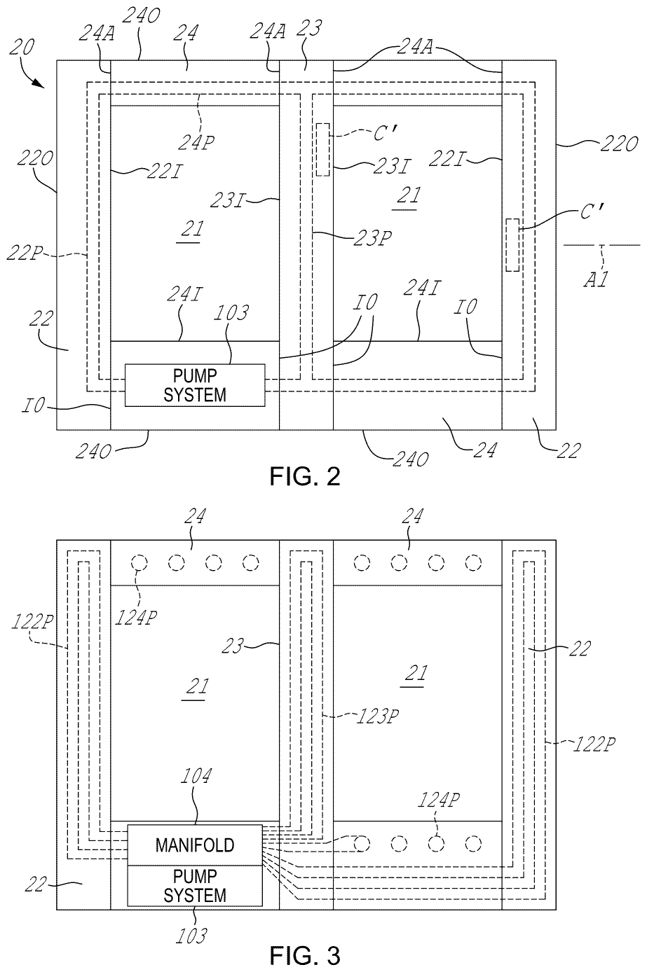

Referring now to FIG. 2, a housing of the rotary internal combustion engine 11 is shown at 20. The description below pertains to a two-rotor engine, but the rotary internal combustion engine 11 may have one or more than two rotors in other embodiments. The housing 20 has interconnected walls defining two rotor cavities 21. The rotor cavities 21 are sized to receive the rotors 12. The interconnected walls include two end walls 22, an intermediate wall 23, and two peripheral walls 24. For a configuration having only one rotor, there would be no intermediate wall. Hence, a number of intermediate wall corresponds to a number of rotor minus one.

In some embodiments, the end walls 22 and the intermediate wall 23 are referred to as side housing and the peripheral walls 24 are referred to as rotor housing. A first peripheral wall of the peripheral walls 24 is disposed between a first one of the two end walls 22 and the intermediate wall 23 while a second peripheral wall of the peripheral walls 24 is disposed between a second one of the two end walls 22 and the intermediate wall 23. The peripheral walls are interspaced between the end walls and the intermediate wall. The peripheral walls 24 extend around a rotation axis A1 of the output shaft 13 (FIG. 1) whereas the two end walls 22 and the intermediate wall 23 extend transversally to the rotation axis A1. Contact interfaces I0 are defined between the two end walls 22/intermediate wall 23 and the two peripheral walls 24. More specifically, the contact interfaces I0 are defined between peripheral axial faces 24A of the peripheral walls 24 and axial faces of the end walls 22 and intermediate axial faces of the intermediate wall 23.

Still referring to FIG. 2, the end walls 22 and the peripheral walls 24 have inner faces 22I, 24I exposed to the rotor cavities 21. The end walls 22 and the peripheral walls 24 have outer faces 22O, 24O opposed to the inner faces 22I, 24I. The intermediate wall 23 has opposed inner faces 23I that are each exposed to a respective one of the rotor cavities 21. These walls extend monolithically from the inner faces 22I, 23I, 24I to the outer faces 22O, 23O, 24O. The walls 22, 23, 24 define passages that are located between the inner faces 22I, 23I, 24I and the outer faces 22O, 23O, 24O. These passages are configured for flowing a fluid, such as oil, for cooling the housing 20 of the rotary internal combustion engine 11 and lubricating components of the engine. In the embodiment shown, the passages are serial passages in that the fluid flows from the pump(s) to end wall cooling passages 22P defined by one of the end walls 22, to peripheral cooling passages 24P of one of the two peripheral walls 24, to intermediate cooling passages 23P of the intermediate wall 23, to peripheral cooling passages 24P of the other of the two peripheral walls 24, and to end wall passages 22P defined by the other of the end walls 22, and back to the pump(s). In this configuration, the passages 22P, 23P, 24P communicate with one another through the contact interfaces I0 defined between the walls of the housing 20.

Alternatively, and as shown in FIG. 3, the cooling passages may be parallel passages 122P, 123P, 124P. Contrary to the configuration of FIG. 2, the cooling passages may be devoid of intersection with the contact interfaces I0 defined between the walls of the housing 20. Such a configuration is described in U.S. Pat. No. 12,264,616, the entire contents of which are incorporated by reference herein. However, some intersection between the cooling passages and the contact interfaces I0 may be required to allow the fluid to reach a manifold 104. The manifold 104 may have a main inlet and a main outlet fluidly connected to the pump system 103 and a plurality of sub-inlets and sub-outlets each outputting and inputting fluid to a respective one of the passages 122P, 123P, 124P.

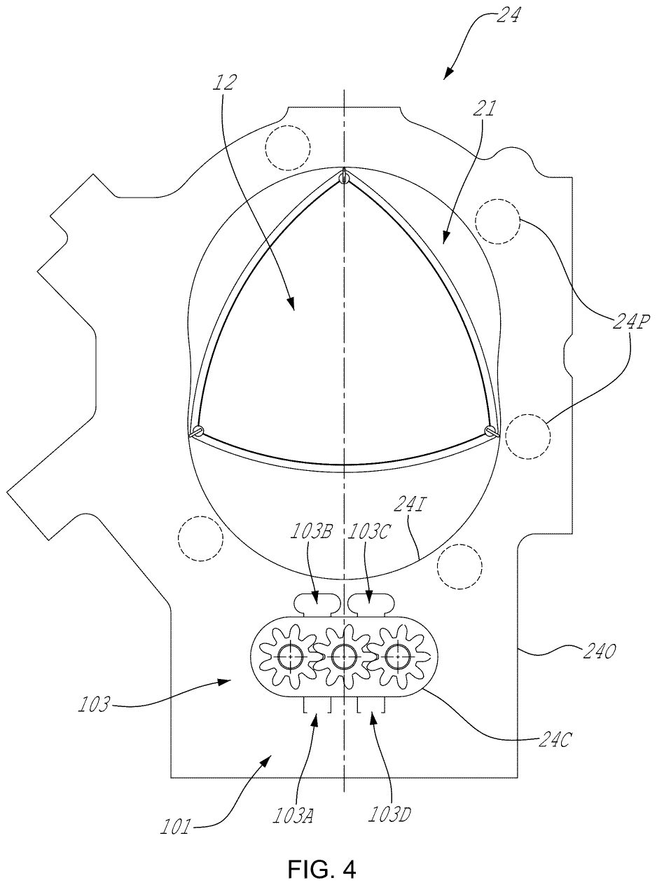

Referring now to FIG. 4, one of the peripheral walls 24 of the housing 20 is shown in greater detail.

In the depicted embodiment, the pump system 103 is embedded into the housing 20 of the rotary internal combustion engine. As illustrated, the peripheral wall 24 defines a pump-receiving cavity 24C between the outer face 24O and the inner face 24I of the peripheral wall 24. The pump system 103 is received in the pump-receiving cavity 24C. It will be appreciated that the pump-receiving cavity 24C may be defined by one of the end walls 22, the intermediate wall 23, one of the peripheral wall 24, or any combination thereof. These alternate positions of the pump-receiving cavity 24C are depicted with dashed lines labelled C′ in FIG. 2.

The pump system 103 defines a first inlet 103A fluidly connectable to a fluid source, such as the fluid tank 101, a first outlet 103B fluidly connected to the passages 22P, 23P, 24P, a second inlet 103C fluidly connected to the passages, and a second outlet 103D fluidly connected to the fluid tank 101. The pump system 103 is thus operable to generate a fluid flow from the first inlet 103A to the first outlet 103B and a scavenge flow from the second inlet 103C to the second outlet 103D. Operation of the pump system 103 therefore generates a flow of the fluid through the passages. Some of these passages are used for cooling and others for injecting a lubricant where appropriate.

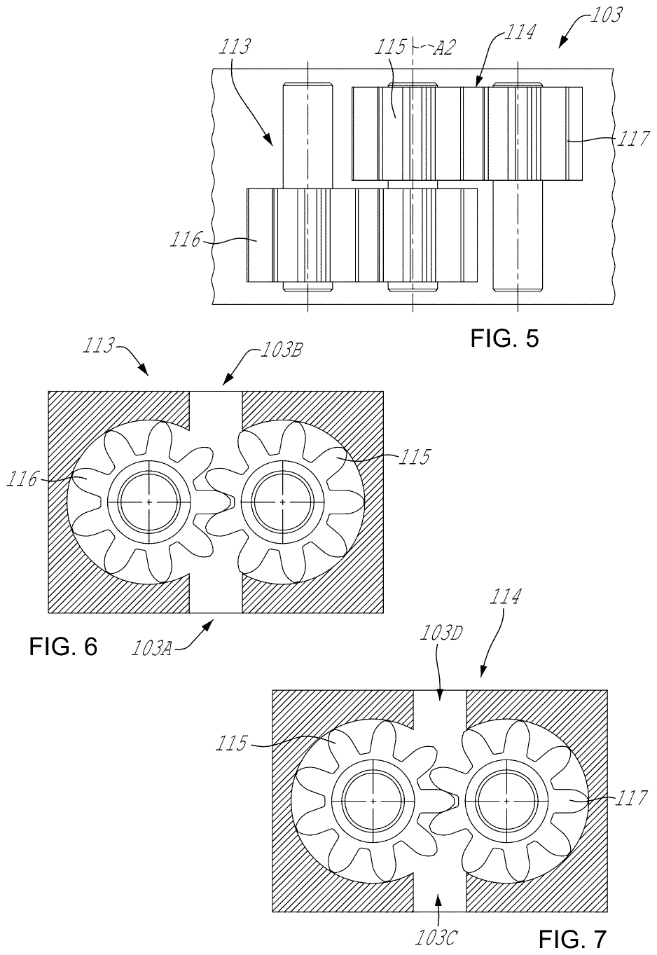

Referring now to FIGS. 5-7, in some embodiments, the pump system 103 includes a first pump 113 driving a flow of the fluid from the first inlet 103A to the first outlet 103B; and a second pump 114 driving a flow of the fluid from the second inlet 103C the second outlet 103D. In some embodiments, the first pump 113 and the second pump 123 are gear pumps defined by gears, namely, a central gear 115, a first lateral gear 116 meshed with the central gear 115, and a second lateral gear 117 meshed with the central gear 115. The first lateral gear 116 and the second lateral gear 117 are disposed on respective opposite sides of the central gear 115. The first pump 113 includes the central gear 115 and the first lateral gear 116 and the second pump 114 includes the central gear 115 and the second lateral gear 117. The central gear 115 is depicted as two gears coaxially mounted on a single shaft. However, the central gear 115 may be a single monolithic gear extending axially a sufficient length to allow being meshed with both of the first lateral gear 116 and the second lateral gear 117. As illustrated, the first lateral gear 116 is axially offset from the second lateral gear 117 relative to an axis of rotation A2 of the central gear 115.

Therefore, by having both of the lateral gears 116, 117 meshed with the central gear 115 on opposite sides thereof, the first lateral gear 116 will turn in an opposite direction as the second lateral gear 117. This allows the two pumps to drive the flow of fluid in opposite direction. Moreover, only a single one of the central gear 115, the first lateral gear 116, and the second lateral gear 117 may be motorized; the other gears will simply rotate via their meshing engagement with the gear being motorized. The central gear 115, or one of the lateral gears, may be drivingly engaged by the rotary internal combustion engine or by an external power source, such as an electric motor.

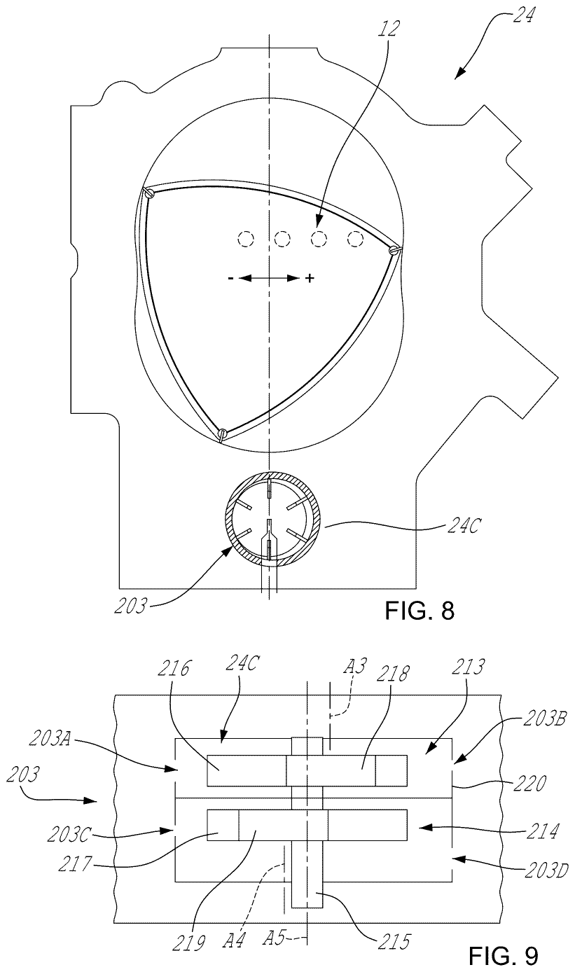

Referring now to FIGS. 8-9, another embodiment of a pump system is shown at 203. The pump system 203 includes a first pump 213 and a second pump 214 that are both unbalanced vane pumps driven by a shaft 215, which may be driven by the rotary internal combustion engine 11 itself or by an electric motor as for the configuration described above. The two pumps 213, 214 are axially offset about the shaft 215. The pumps define the first inlet 203A, the first outlet 203B, the second inlet 203C, and the second outlet 203D of the pump system 203. The two-pumps 213, 214 are received into the pump-receiving cavity 24C of the peripheral wall 24. Each of the two pumps 213, 214 include a rotor 216, 217 mounted on a cam 218, 219 each having a central axis A3, A4 being radially offset from a rotation axis A5 of the shaft 215. As known, the rotors 216, 217 define slots receiving vanes that are biased radially outwardly against a pump housing 220. Rotation of the shaft 215 causes the cams 218, 219 and the rotors 216, 217 mounted thereto to rotate eccentrically about the rotation axis A5 of the shaft 215. In other words, the two rotors 216, 217 orbit around the rotation axis A5 of the shaft 215. The rotation of the rotors as such create zones of depression suctioning fluid into the pump housing 220 and zones of higher pressure pushing the fluid out.

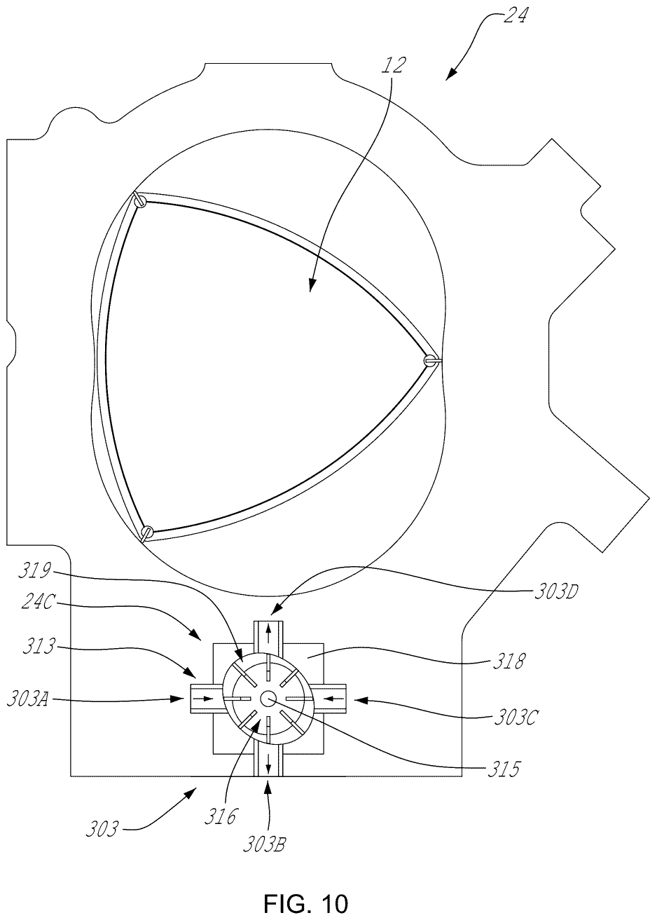

Referring now to FIG. 10, another embodiment of a pump system is shown at 303. In the embodiment shown, the pump system 303 includes a single balanced vane pump 313 defining the first inlet 303A, the first outlet 303B, the second inlet 303C, and the second outlet 303D. The pump 313 includes a housing 318 within which rotates a rotor 316 driven by a shaft 315. The rotor 316 and the shaft 315 are coaxial in this embodiment. The housing 318 has a rotor-receiving cavity 319 having an elliptical shape. Rotation of the rotor 316 causes the vanes to move radially inwardly and outwardly as they follow a contour of the shape of the rotor-receiving cavity 319. This shape creates successively two zones of depression and two zones of higher pressures to act effectively as two distinct pumps. The pump 313 therefore draws fluid from the fluid tank and pushes that fluid into the cooling passages of the housing 20 and draws the heated fluid from the fluid passages and pushes this fluid through the heat exchanger 102 and the cycle continues.

Incorporating the pump system into the housing of the rotary internal combustion engine may allow the engine to have a more compact overall footprint, increase efficiency of the fluid system, simplify the system, and so on.

It is noted that various connections are set forth between elements in the preceding description and in the drawings. It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities. The term “connected” or “coupled to” may therefore include both direct coupling (in which two elements that are coupled to each other contact each other) and indirect coupling (in which at least one additional element is located between the two elements).

It is further noted that various method or process steps for embodiments of the present disclosure are described in the preceding description and drawings. The description may present the method and/or process steps as a particular sequence. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the description should not be construed as a limitation.

Furthermore, no element, component, or method step in the present disclosure is intended to be dedicated to the public regardless of whether the element, component, or method step is explicitly recited in the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various aspects of the present disclosure have been disclosed, it will be apparent to those of ordinary skill in the art that many more embodiments and implementations are possible within the scope of the present disclosure. For example, the present disclosure as described herein includes several aspects and embodiments that include particular features. Although these particular features may be described individually, it is within the scope of the present disclosure that some or all of these features may be combined with any one of the aspects and remain within the scope of the present disclosure. References to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. The use of the indefinite article “a” as used herein with reference to a particular element is intended to encompass “one or more” such elements, and similarly the use of the definite article “the” in reference to a particular element is not intended to exclude the possibility that multiple of such elements may be present.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A rotary internal combustion engine, comprising:
a housing having a plurality of walls defining a rotor cavity, the plurality of walls having respective inner faces exposed to the rotor cavity and respective outer faces opposed to the inner faces, the plurality of walls defining passages between the inner faces and the outer faces, at least one wall of the plurality of walls defining a pump-receiving cavity embedded within the at least one wall between a corresponding outer face of the outer faces and a corresponding inner face of the inner faces, the pump-receiving cavity in fluid communication with the passages;
a rotor rotatably received within the rotor cavity of the housing, the rotor drivingly engaged to an output shaft; and
a pump system received into the pump-receiving cavity of the housing, the pump system including a first inlet fluidly connectable to a fluid source, a first outlet fluidly connected to the passages, a second inlet fluidly connected to the passages, and a second outlet fluidly connectable to the fluid source, the pump system operable to generate a fluid flow from the first inlet to the first outlet and a scavenge flow from the second inlet to the second outlet.

2. The rotary internal combustion engine of claim 1, wherein the pump system includes:
a first pump driving a flow of the fluid from the first inlet to the first outlet; and
a second pump driving a flow of the fluid from the second inlet to the second outlet.

3. The rotary internal combustion engine of claim 2, wherein the first pump and the second pump are gear pumps.

4. The rotary internal combustion engine of claim 3, wherein the gear pumps include a central gear, a first lateral gear meshed with the central gear, and a second lateral gear meshed with the central gear, the first lateral gear and the second lateral gear disposed on respective opposite faces of the central gear, the first pump including the central gear and the first lateral gear, the second pump including the central gear and the second lateral gear.

5. The rotary internal combustion engine of claim 4, wherein the first lateral gear is axially offset from the second lateral gear relative to an axis of rotation of the first lateral gear.

6. The rotary internal combustion engine of claim 2, wherein the first pump and the second pump are unbalanced vane pumps.

7. The rotary internal combustion engine of claim 6, wherein the unbalanced vane pumps include a first pump rotor and a second pump rotor axially offset from one another relative to a rotational axis of the first pump rotor.

8. The rotary internal combustion engine of claim 1, wherein the pump system includes a single balanced vane pump defining the first inlet, the first outlet, the second inlet, and the second outlet.

9. The rotary internal combustion engine of claim 1, wherein the pump system is drivingly engaged by the output shaft.

10. An aircraft power plant, comprising:
an output shaft for driving a rotatable load;
a fluid tank;
a rotary internal combustion engine having:
a housing having a plurality of interconnected walls enclosing rotor cavities, the plurality of interconnected walls having respective inner faces exposed to the rotor cavities and respective outer faces opposed to the inner faces, fluid passages defined by the plurality of interconnected walls between the inner faces and the outer faces;
a pump-receiving cavity embedded within at least one wall of the plurality of interconnected walls between a corresponding outer face of the outer faces and a corresponding inner face of the inner faces, the pump-receiving cavity in fluid communication with the fluid passages; and
rotors each rotatably received within a respective one of the rotor cavities of the housing, the rotors drivingly engaged to the output shaft; and
a main pump received into the pump-receiving cavity, the main pump having a main inlet fluidly connected to the fluid tank and a main outlet fluidly connected to inlets of the fluid passages of the housing; and
a scavenge pump received into the pump-receiving cavity, the scavenge pump having a scavenge inlet fluidly connected to outlets of the fluid passages and a scavenge outlet fluidly connected to the fluid tank.

11. The aircraft power plant of claim 10, wherein the fluid tank is defined by a fluid-receiving volume defined by the housing.

12. The aircraft power plant of claim 10, wherein the main pump and the scavenge pump are gear pumps.

13. The aircraft power plant of claim 12, wherein the gear pumps include a central gear, a first lateral gear meshed with the central gear, and a second lateral gear meshed with the central gear, the first lateral gear and the second lateral gear disposed on respective opposite faces of the central gear, the first pump including the central gear and the first lateral gear, the second pump including the central gear and the second lateral gear.

14. The aircraft power plant of claim 13, wherein the first lateral gear is axially offset from the second lateral gear relative to an axis of rotation of the first lateral gear.

15. The aircraft power plant of claim 13, wherein a gear of the central gear, the first lateral gear, and the second lateral gear is drivingly engaged by the output shaft.

16. The aircraft power plant of claim 10, wherein the main pump and the scavenge pump are unbalanced vane pumps.

17. The aircraft power plant of claim 16, wherein the unbalanced vane pumps include a first pump rotor and a second pump rotor axially offset from one another relative to a rotational axis of the first pump rotor.

18. The aircraft power plant of claim 10, wherein the main pump and the scavenge pump are defined by a single balanced vane pump defining the main inlet, the main outlet, the scavenge inlet, and the scavenge outlet.

19. The aircraft power plant of claim 10, wherein the interconnected walls include end walls and a peripheral wall located between the end walls, the end walls and the peripheral wall conjointly defining a rotor cavity of the rotor cavities, the passages extending through interfaces, an interface of the interfaces defined between an end wall of the end walls and the peripheral wall.

20. The aircraft power plant of claim 19, wherein the pump-receiving cavity is defined by the peripheral wall.
